(19) United States
(12) Patent Application Publication
(10) Pub. No.: US 2015/0085503 A1
(43) Pub. Date: Mar. 26, 2015

(54) LIGHTING APPARATUS

(71) Applicants: Yun Whan Na, Suwon-si (KR); Han Byul Chang, Seoul (KR); Yong Keun Jee, Suwon-si (KR); Kyu Cheol Kang, Suwon-si (KR); Choong Gunn Park, Seoul (KR); Jin Jong Kim, Hwaseong-si (KR); Tae Hong Lee, Seoul (KR); Choul Ho Lee, Suwon-si (KR)

(72) Inventors: Yun Whan Na, Suwon-si (KR); Han Byul Chang, Seoul (KR); Yong Keun Jee, Suwon-si (KR); Kyu Cheol Kang, Suwon-si (KR); Choong Gunn Park, Seoul (KR); Jin Jong Kim, Hwaseong-si (KR); Tae Hong Lee, Seoul (KR); Choul Ho Lee, Suwon-si (KR)

(73) Assignee: SAMSUNG ELECTRONICS CO., LTD., Suwon-si, Gyeonggi-do (KR)

(21) Appl. No.: 14/240,308

(22) PCT Filed: Aug. 23, 2011
(86) PCT No.: PCT/KR2011/006206

§ 371 Date: May 2, 2014

(51) Int. Cl. F21V 29/00; F21K 99/00; F21V 23/06; F21V 29/02

(52) U.S. Cl. CPC F21V 29/2268; F21V 29/004; F21V 29/02; F21K 9/13; F21V 29/40; F21V 29/248; F21V 23/06; F21V 29/006; F21Y 2101/02
USPC 362/373

(57) ABSTRACT

An illuminating device includes a light source module; a heat radiator including a heat radiating plate having a cavity open toward a front surface thereof and receiving the light source module therein and ventilation holes disposed along an edge of the cavity, and heat radiating fins extending to a rear surface of the heat radiating plate, disposed in a radial manner along an edge of the heat radiating plate and positioned between the ventilation holes to form ventilation channels therebetween communicating with the ventilation holes; a cooler fixed to the heat radiator to be in contact with ends of the heat radiating fins and including air jet holes allowing air to be blown toward the heat radiator; and an electrical connector connected to the light source module and the cooler and supplying electrical signals thereto.

### TECHNICAL FIELD

The present disclosure relates to an illuminating device, and more particularly, to an illuminating device using a light emitting device as a light source.

### BACKGROUND ART

A light emitting diode (LED) is a semiconductor light emitting device capable of implementing light of various colors through the use of various compound semiconductor materials such as GaAs, AlGaAs, GaN, InGaInP, and the like.

Since LEDs have several advantages such as excellent monochromic peak wavelengths, excellent optical efficiency, compactness, environmental friendliness, low power consumption, and the like, LEDs have increasingly been applied to various devices such as TVs, computers, illuminating devices, automobiles, and the like, and fields of application thereof have been broadened.

Illuminating devices using LEDs are becoming increasingly prominent in these fields, since they have a relatively long lifespan compared to incandescent lamps or halogen lamps.

However, LEDs generate a large amount of heat depending on magnitudes of current applied thereto, and the heat may cause reductions in light emitting efficiency and lifespan.

In order to secure a long lifespan of the illuminating device, research into a structure optimized for heat dissipation is required, and research for structural improvement in efficient heat dissipation is being actively conducted.

### DISCLOSURE

### Technical Problem

An aspect of the present disclosure may provide an illuminating device having a simple structure, increasing an amount of light output of a light emitting device and extending a lifespan by improving heat dissipation.

### Technical Solution

According to an aspect of the present disclosure, an illuminating device may include: a light source module including a substrate and at least one light emitting device package mounted on the substrate; a heat radiator including a heat radiating plate having a cavity provided at a center thereof open toward a front surface thereof and receiving the light source module therein and a plurality of ventilation holes disposed along an edge of the cavity, and a plurality of heat radiating fins extending to a rear surface of the heat radiating plate and disposed in a radial manner along an edge of the heat radiating plate to dissipate heat generated by the light source module, and positioned between the plurality of ventilation holes to form ventilation channels therebetween communicating with the plurality of ventilation holes; a cooler fixed to the heat radiator to be in contact with ends of the heat radiating fins and including a plurality of air jet holes in a surface thereof such that air is blown to the heat radiator; and an electrical connector connected to the light source module and the cooler and supplying an external electrical signal to the at least one light emitting device package and the cooler.

The heat radiating plate may include a plurality of exhaust holes disposed along an inner circumferential surface of the cavity and communicating with the respective ventilation channels.

The cooler may include a main body having an internal space having a predetermined size and including the plurality of air jet holes in a surface thereof facing the heat radiating fins; a membrane structure disposed inside the main body and generating an air flow through a vertical rocking motion to allow the air to be blown to the heat radiating fins through the air jet holes; and an actuator driving the membrane structure to perform the vertical rocking motion when the electrical signal is applied thereto.

The plurality of air jet holes may be disposed along an edge of the main body and positioned between the plurality of heat radiating fins to allow the air to be blown between the respective heat radiating fins.

The illuminating device may further include a cover member disposed on the front surface of the heat radiating plate to cover the cavity and protect the light source module.

The cover member may include an insertion hole provided in a position corresponding to the at least one light emitting device package to allow a portion of the at least one light emitting device package to be exposed to the outside.

According to another aspect of the present disclosure, an illuminating device may include a light source module including a substrate and at least one light emitting device package mounted on the substrate; a cooler having the light source module mounted on a surface thereof and cooling the light source module when a refrigerant injected thereinto is evaporated and discharged as vapor; a heat radiator including a heat radiating plate having a cavity provided at a center thereof open toward a front surface thereof and receiving the light source module and the cooler therein and a plurality of ventilation holes disposed along an edge of the cavity, and a plurality of heat radiating fins extending to a rear surface of the heat radiating plate, disposed in a radial manner along an edge of the heat radiating plate, and positioned between the plurality of ventilation holes to form ventilation channels therebetween communicating with the plurality of ventilation holes; and an electrical connector connected to the light source module and the cooler and supplying an external electrical signal to the at least one light emitting device package and the cooler.

The heat radiating plate may include a plurality of exhaust holes disposed along an inner circumferential surface of the cavity to communicate with the respective ventilation channels.

The cooler may include a main body having a reservoir receiving the refrigerant through a supply pipe and having a predetermined size, and an evaporation space communicating with the reservoir through a plurality of nozzles and allowing the refrigerant injected through the plurality of nozzles to be evaporated and discharged as vapor through a discharge pipe; and a condenser connected to the supply pipe and the discharge pipe to supply the refrigerant to the reservoir and receive the evaporated vapor from the evaporation space.

The supply pipe and the discharge pipe may be disposed in a surface of the main body opposite to the surface thereof on which the light source module is mounted.

The illuminating device may further include a pump allowing the refrigerant inside the condenser to be supplied to the reservoir through the supply pipe.

The illuminating device may further include a cover member disposed on the front surface of the heat radiating plate to cover the cavity and protect the light source module.

The cover member may include an insertion hole provided in a position corresponding to the at least one light emitting device package to allow a portion of the at least one light emitting device package to be exposed to the outside.

### Advantageous Effects

According to exemplary embodiments of the present disclosure, air circulation may be facilitated to allow heated air to be discharged without retention thereof, and heat dissipation efficiency may be maximized using latent heat of vaporization through a liquid-vapor phase change of a refrigerant, whereby a high-output LED illuminating device may be implemented.

### DESCRIPTION OF DRAWINGS

The above and other aspects, features and other advantages of the present disclosure will be more clearly understood from the following detailed description taken in conjunction with the accompanying drawings, in which:

FIG. 1 is an exploded view illustrating an illuminating device according to an exemplary embodiment of the present disclosure;

FIG. 2 is a view illustrating a light source module and a cover member in the illuminating device of FIG. 1;

FIG. 3 is a view illustrating a heat radiator in the illuminating device of FIG. 1;

FIG. 4 is a view illustrating a cooler in the illuminating device of FIG. 1;

FIG. 5 is a view schematically illustrating an operating principle of the cooler of FIG. 4;

FIG. 6 is a view illustrating air flow in the heat radiator coupled to the cooler;

FIG. 7 is a view illustrating an illuminating device according to another exemplary embodiment of the present disclosure;

FIG. 8 is a view schematically illustrating a cooler in the illuminating device of FIG. 7; and

FIG. 9 is a view schematically illustrating refrigerant flow in the cooler of FIG. 7.

### BEST MODE

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

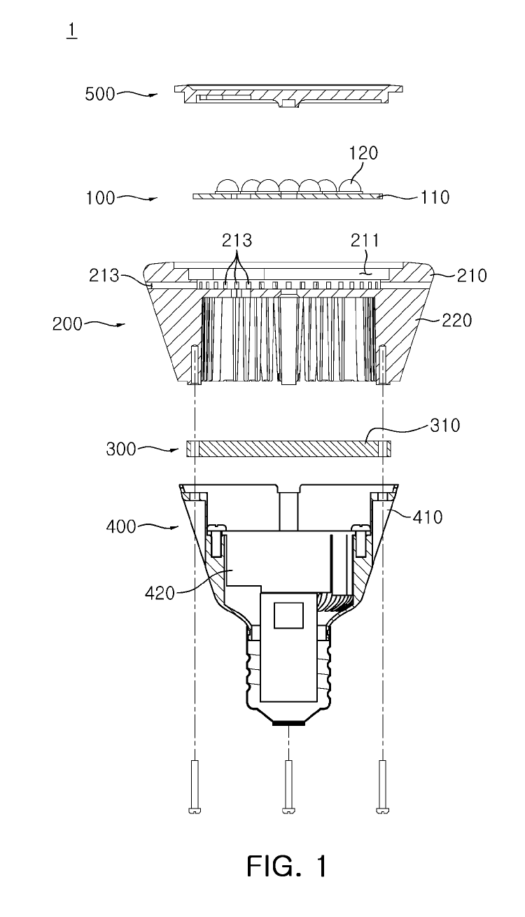

An illuminating device according to an exemplary embodiment of the present disclosure will be described in detail with reference to FIGS. 1 through 6.

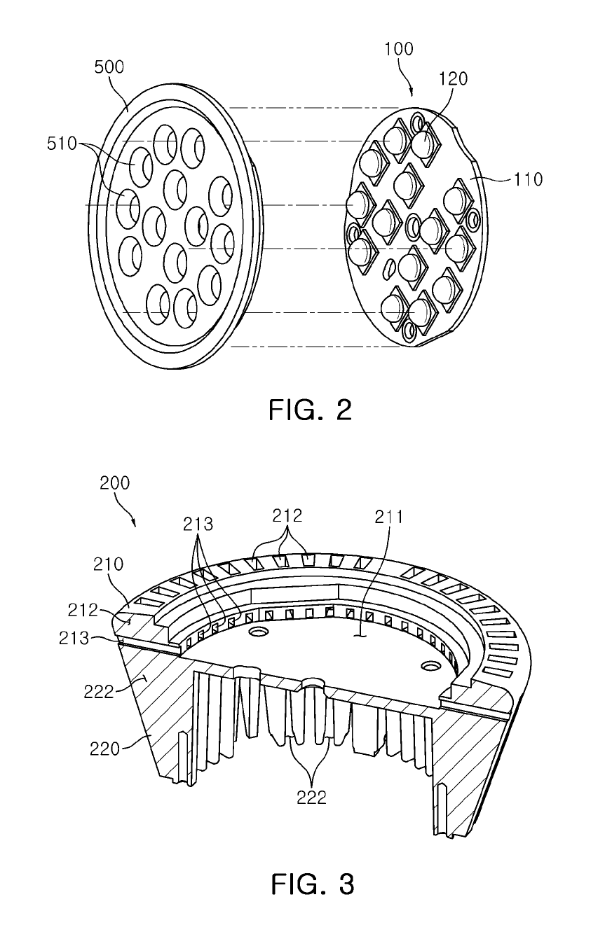

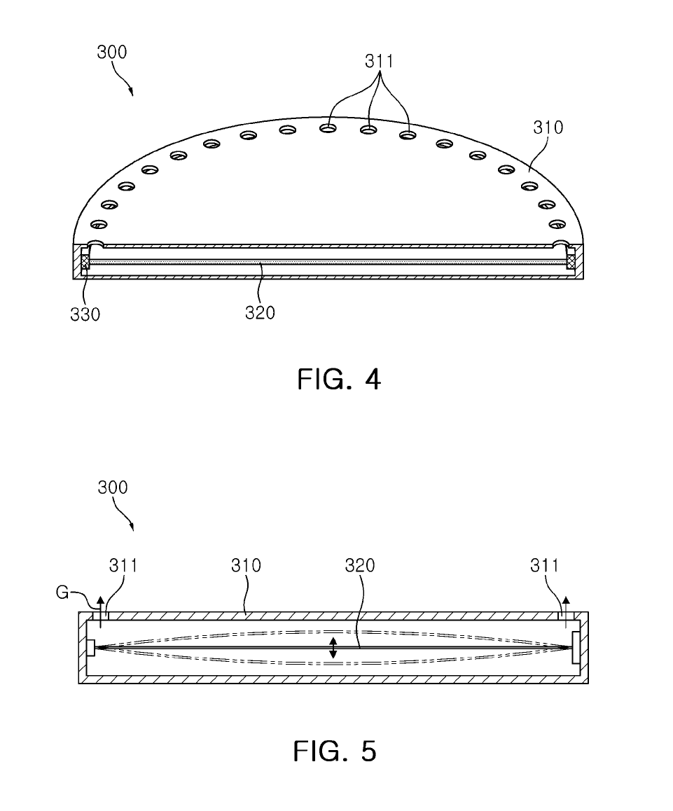

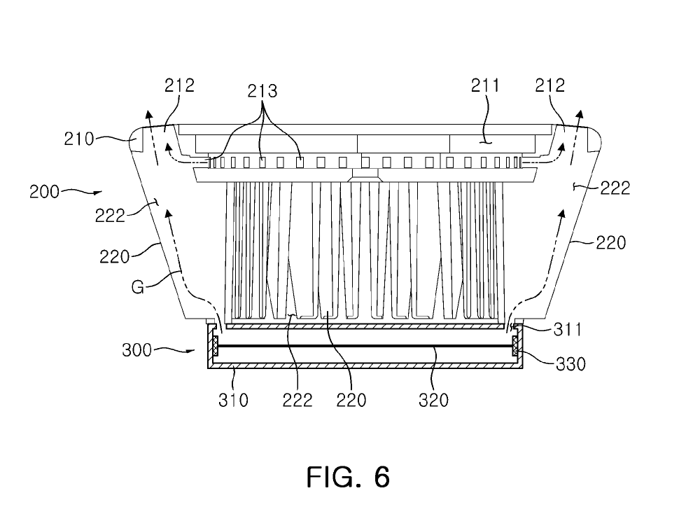

FIG. 1 is an exploded view illustrating an illuminating device according to an exemplary embodiment of the present disclosure; FIG. 2 is a view illustrating a light source module and a cover member in the illuminating device of FIG. 1; FIG. 3 is a view illustrating a heat radiator in the illuminating device of FIG. 1; FIG. 4 is a view illustrating a cooler in the illuminating device of FIG. 1; FIG. 5 is a view schematically illustrating an operating principle of the cooler of FIG. 4; and FIG. 6 is a view illustrating air flow in the heat radiator coupled to the cooler.

With reference to FIGS. 1 through 6, an illuminating device 1 according to an exemplary embodiment of the present disclosure may include a light source module 100, a heat radiator 200, a cooler 300 and an electrical connector 400, and may further include a cover member 500 protecting the light source module 100.

As illustrated in FIGS. 1 and 2, the light source module 100 may include a substrate 110 and at least one light emitting device package 120 mounted on the substrate 110.

The light source module 100 may include a light emitting diode (LED), a semiconductor device capable of emitting light having a predetermined wavelength when an external electrical signal is applied thereto, as a light source, and the light emitting device package 120 may include a single LED or a plurality of LEDs disposed therein.

The substrate 110 may be a type of printed circuit board (PCB), and may be made of an organic resin material containing epoxy, triazine, silicon, polyimide, or the like, and other organic resin materials, or may be made of a ceramic material such as AlN, Al₂O₃, or the like, or a metal and a metal compound. For example, the substrate 110 may be a metal-core printed circuit board (MCPCB).

A circuit wiring (not shown) may be electrically connected to the light emitting device package 120 on a surface of the substrate 110 opposite to a mounting surface of the substrate 110 on which the light emitting device package 120 is mounted. The surface of the substrate 110 opposite to the mounting surface thereof may be assembled to the heat radiator 200 using a thermal interface material (not shown) such as a heat radiation pad, a phase change material, heat radiation tape, or the like, interposed therebetween, in order to decrease heat resistance.

The heat radiator 200 may serve as a housing accommodating and supporting the light source module 100, as well as a heat sink dissipating heat generated in the light source module 100 externally.

As illustrated in FIGS. 1 and 3, the heat radiator 200 may include a heat radiating plate 210 having a cavity 211 open toward a front surface thereof to receive the light source module 100 therein, and a plurality of heat radiating fins 220 extending to a rear surface of the heat radiating plate 210 and disposed in a radial manner along an edge of the heat radiating plate 210.

The heat radiating plate 210 may include a plurality of ventilation holes 212 formed along an edge of the cavity 211 defined at the center of the heat radiating plate 210. The plurality of heat radiating fins 220 may be disposed between the plurality of ventilation holes 212, and ventilation channels 222 may be formed between the plurality of heat radiating fins 220 to communicate with the plurality of ventilation holes 212, respectively.

Therefore, air flowing through the ventilation channels 222 disposed between the heat radiating fins 220 may be discharged to the outside via the ventilation holes 212, thereby cooling the heat radiating fins 220. The ventilation channels 222 disposed in the radial manner may communicate with the respective ventilation holes 212, thereby allowing a flow of heated air to be maintained without retention thereof.

In addition, the heat radiating plate 210 may include a plurality of exhaust holes 213 disposed along an inner circumferential surface of the cavity 211 to communicate with the respective ventilation channels 222. That is, the exhaust holes 213 may be disposed in the inner circumferential surface of the cavity 211 to be adjacent to the light source module 100 received in the cavity 211, thereby releasing the heat generated by the light emitting module 100 from the cavity 211 to the outside.

Since the exhaust holes 213 communicate with the respective ventilation channels 222, air G heated by the heat generated in the light emitting module 100 may be discharged to the ventilation channels 222 via the exhaust holes 213 without being retained in the cavity 211, whereby the temperature inside the cavity 211 may be lowered to cool the light source module 100.

Meanwhile, the cooler 300 may be fixed to the heat radiator 200 to be in contact with rear ends of the heat radiating fins 220, and may include a plurality of air jet holes 311 on a surface thereof such that the air G may be blown toward the heat radiator 200. That is, the cooler 300 may forcibly create the air flow, thereby cooling the heat radiator 200. Here, the air G may be blown via the air jet holes 311 in a micro air jet manner.

With reference to FIGS. 4 and 5, the cooler 300 may include a main body 310 having an internal space of a predetermined size, a membrane structure 320 disposed in the main body 310, and an actuator 330 driving the membrane structure 320.

The main body 310 may have a disk-shaped structure in contact with the rear ends of the heat radiating fins 220 disposed in the radial manner, and may have a size corresponding to an outer circumferential surface of an imaginary circle drawn by the heat radiating fins 220; however, the main body 310 is not limited thereto, and may have various shapes such as a polygonal shape. The plurality of air jet holes 311 may be formed to penetrate a surface of the main body 310 facing the heat radiating fins 220. In this case, the plurality of air jet holes 311 may be disposed along an edge of the main body 310. The air jet holes 311 may be positioned between the plurality of heat radiating fins 220, so that the air G may be blown between the heat radiating fins 220.

The membrane structure 320 may be disposed inside the main body 310, generate the air flow through a vertical or horizontal rocking motion, and allow the air to be blown to the heat radiating fins 220 via the air jet holes 311. The membrane structure 320 may be made of a material having elasticity such as rubber.

The actuator 330 may be a driving source allowing the membrane structure 320 to perform the vertical or horizontal rocking motion when an electrical signal is applied thereto. A stepping motor, a piezoelectric motor, or the like, may be used for the actuator 330. The actuator 330, along with the membrane structure 320, may be disposed within the main body 310. Alternatively, the actuator 330 may be disposed outside the main body 310.

The cooler 300 according to the present embodiment may facilitate a wake effect caused by a vortex in the flow of the air forcibly blown into the ventilation channels 222 formed between the heat radiating fins 220 as illustrated in FIG. 6, thereby improving heat transfer on surfaces of the heat radiating fins 220 and maximizing a cooling effect of the heat radiating fins 220. In addition, the cooler 300 may forcibly create the air flow through the ventilation channels 222, so that the heat retained in the cavity 211 may be discharged to the outside due to a pressure difference between the inside and outside of the cavity 211 created by a forced flow field, whereby effective heat dissipation may be implemented.

The electrical connector 400 may supply an electrical signal to the light source module 100 and the cooler 300 through a switched mode power supply (SMPS) 420 disposed inside a housing 410. The housing 410 may cover and protect the cooler 300 disposed at the rear of the heat radiating fins 220. In this case, an outer surface of the housing 410 and outer surfaces of the heat radiating fins 220 may be continuously connected to one another along contact surfaces therebetween.

The cover member 500 may be disposed on the front surface of the heat radiating plate 210 to cover the cavity 211 and protect the light source module 100. The cover member 500 may be made of polycarbonate (PC), plastic, silica, acryl, glass or the like. The cover member 500 may be made of a transparent material for light transmission, but is not limited thereto.

The cover member 500 may include insertion holes 510 formed in positions corresponding to the respective light emitting device packages 120, as illustrated in FIG. 2, so that the insertion holes 510 allow portions of the light emitting device packages 120 to be exposed outwards. The insertion holes 510 may be disposed directly above the respective light emitting device packages 120 to allow upper portions of the light emitting device packages 120 to be inserted thereinto and be externally protruded to be exposed.

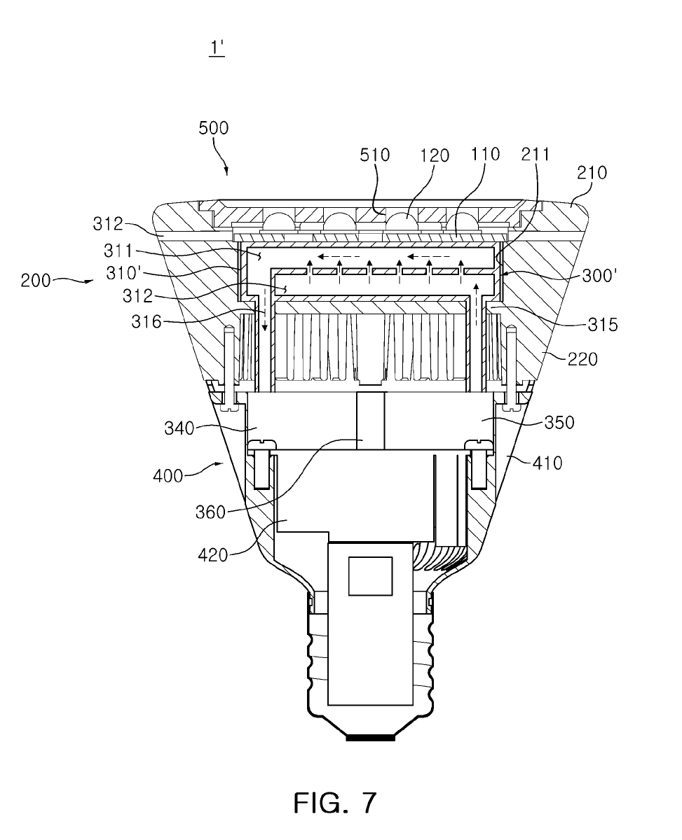

Meanwhile, an illuminating device according to another exemplary embodiment of the present disclosure will be described with reference to FIGS. 7 through 9.

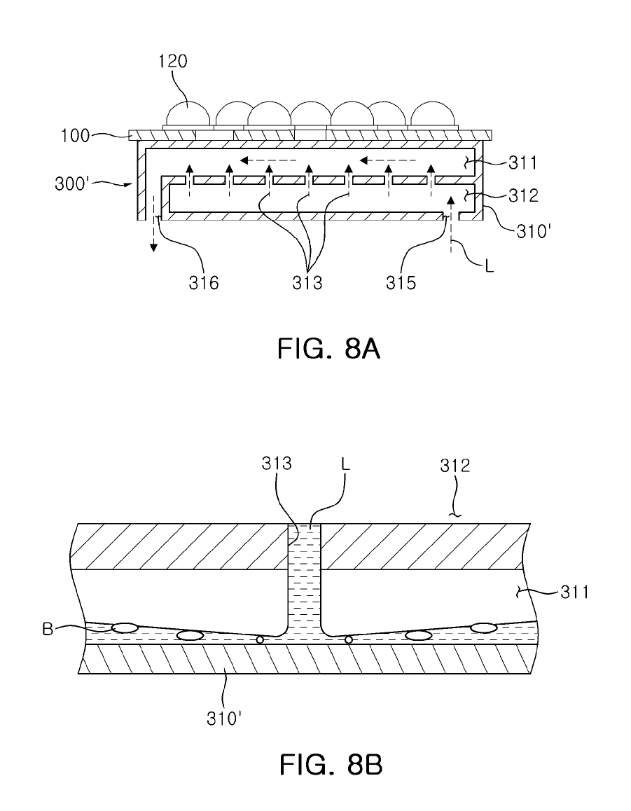

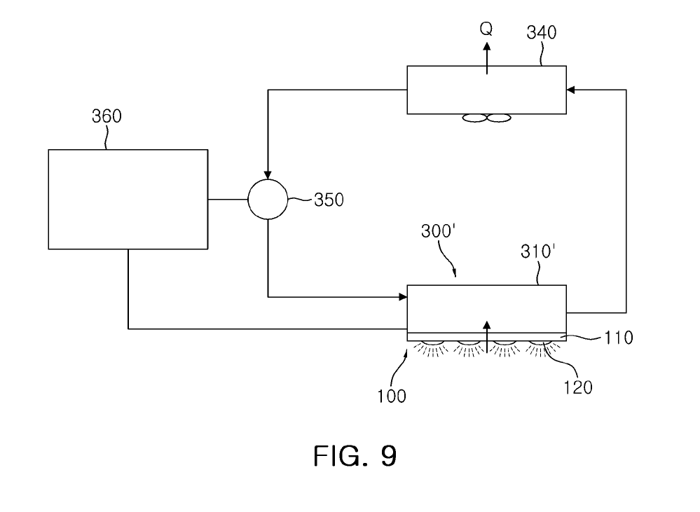

FIG. 7 is a view illustrating an illuminating device according to another exemplary embodiment of the present disclosure. FIGS. 8A and 8B are views schematically illustrating a cooler in the illuminating device of FIG. 7, and FIG. 9 is a view schematically illustrating refrigerant flow in the cooler of FIG. 7.

An illuminating device 1′ according to the embodiment of FIG. 7 has substantially the same structure as that of the illuminating device 1 according to the embodiment of FIG. 1, except that a cooler 300′, along with the light source module 100, is installed in the cavity 211 of the heat radiating plate 210 while being disposed between the light source module 100 and the heat radiator 200, and cools the heat radiator 200 using a refrigerant instead of air.

With reference to FIGS. 7 through 9, the illuminating device 1′ according to the present embodiment may include the light source module 100, the heat radiator 200, the cooler 300′ and the electrical connector 400, and may further include the cover member 500 protecting the light source module 100.

The light source module 100 may include the substrate 110 and at least one light emitting device package 120 mounted on the substrate 110.

The heat radiator 200 may include the heat radiating plate 210 having the cavity 211 open toward the front surface thereof and receiving the light source module 100 and the cooler 300′ therein, and the plurality of heat radiating fins 220 extending to the rear surface of the heat radiating plate 210 and disposed in a radial manner along the edge of the heat radiating plate 210.

As illustrated, the heat radiating plate 210 may include the plurality of ventilation holes 212 formed along the edge of the cavity 211 provided at the center of the heat radiating plate 210. The plurality of heat radiating fins 220 may be disposed between the plurality of ventilation holes 212, and the ventilation channels 222 may be formed between the heat radiating fins 220 to communicate with the plurality of ventilation holes 212. In addition, the heat radiating plate 210 may include the plurality of exhaust holes 213 disposed along the inner circumferential surface of the cavity 211 to communicate with the respective ventilation channels 222.

The ventilation holes 212 and the exhaust holes 213 may communicate with the ventilation channels 222, whereby air introduced through the ventilation holes 212 may flow through the ventilation channels 222 formed between the heat radiating fins 220 to cool the heat radiating fins 220. In this case, the heated air flowing from the cavity 211 to the ventilation channels 222 may be discharged externally through the exhaust holes 213, whereby heat release by natural convection may be facilitated.

Meanwhile, the cooler 300′ may be disposed within the cavity 211 while having the light source module 100 mounted on a front surface thereof. The cooler 300′ may have an internal space having a predetermined size, and when a refrigerant L injected into the internal space is evaporated and discharged as vapor, the cooler 300′ may forcibly cool the light source module 100.

As illustrated in FIG. 8A, the cooler 300′ may include a main body 310′ having a reservoir 312 and an evaporation space 311 that correspond to the internal space having the predetermined size, and a condenser 340 connected to the reservoir 312 and the evaporation space 311.

The main body 310′ may have a cylindrical structure and the light source module 100 may be disposed to be in contact with the surface of the substrate 110 opposite to the mounting surface thereof on which the light emitting device packages 120 are mounted. A diameter of the main body 310′ may correspond to that of the inner circumferential surface of the cavity 211, so that the main body 310′ may be installed in the cavity 211.

The main body 310′ may include the reservoir 312 and the evaporation space 311 corresponding to the internal space having the predetermined size. The reservoir 312 and the evaporation space 311 may be separate spaces communicating with each other using a plurality of nozzles 313. The evaporation space 311 may be adjacent to the surface of the main body 310′ on which the light source module 100 is mounted, such that the evaporation space 311 may be disposed between the light source module 100 and the reservoir 312.

The reservoir 312 may receive the refrigerant L supplied from the outside of the main body 310′ through a supply pipe 315 and inject the received refrigerant L into the evaporation space 311 through the nozzles 313. Here, the refrigerant L may be injected through the nozzles 313 in a micro liquid jet manner. The refrigerant L may be water, acetone, FC-72, or the like, but is not limited thereto.

The heat generated by the light source module 100 may be discharged to the outside when the refrigerant L injected through the nozzles 313 is evaporated as vapor in the evaporation space 311 due to the heat and is discharged to the outside of the evaporation space 311 through a discharge pipe 316. That is, as illustrated in FIG. 8B, vapor bubbles B may occur in the refrigerant L injected into the evaporation space 311 when nucleate boiling occurs, and a surface temperature of the evaporation space 311 may be lowered through a phase change during the nucleate boiling.

The supply pipe 315 and the discharge pipe 316 may be disposed in a surface of the main body 310′ opposite to the surface thereof on which the light source module 100 is mounted. The supply pipe 315 may be connected to the reservoir 312 and the discharge pipe 316 may be connected to the evaporation space 311.

As illustrated in FIGS. 7 and 9, the condenser 340 may be connected to the discharge pipe 316, such that the condenser 340 may receive the evaporated vapor and the heated refrigerant L from the evaporation space 311 through the discharge pipe 316, releasing the heat and cooling the refrigerant L. In addition, the condenser 340 may resupply the refrigerant L to the reservoir 312.

A pump 350 may be provided between the condenser 340 and the reservoir 312, such that the refrigerant L within the condenser 340 may be supplied to the reservoir 312 through the supply pipe 315 using a predetermined amount of pressure from the pump 350. In addition, a controller 360 may be further provided to control the operation of the pump 350.

Since the cooler 300′ according to the present embodiment uses latent heat of vaporization through a liquid-vapor phase change of the refrigerant L, it may be relatively effective for dissipating heat of a high-power product, as compared to a liquid cooling method using sensible heat.

In addition, the heat radiating plate 210 and the heat radiating fins 220 having the cooler 300′ installed therein may allow the heat to be additionally discharged by natural convection, whereby heat dissipation efficiency may be further improved.

The electrical connector 400 may supply an electrical signal to the light source module 100 and the cooler 300′, particularly to the condenser 340 and the pump 350, through the SMPS 420 disposed inside the housing 410. The housing 410 may cover and protect the condenser 340 and the pump 350 disposed at the rear of the heat radiating fins 220. In this case, the outer surface of the housing 410 and the outer surfaces of the heat radiating fins 220 may be continuously connected to one another along contact surfaces therebetween.

The cover member 500 may be disposed on the front surface of the heat radiating plate 210 to cover the cavity 211 and protect the light source module 100. The cover member 500 may be made of polycarbonate (PC), plastic, silica, acryl, glass or the like. The cover member 500 may be made of a transparent material for light transmission, but is not limited thereto.

In particular, the cover member 500 may include the insertion holes 510 formed in positions corresponding to the respective light emitting device packages 120, so that the insertion holes 510 allow portions of the light emitting device packages 120 to be exposed to the outside. The insertion holes 510 may be disposed directly above the respective light emitting device packages 120 to allow the upper portions of the light emitting device packages 120 to be inserted thereinto and be externally protruded to be exposed.

1. An illuminating device comprising:
a light source module including a substrate and at least one light emitting device package mounted on the substrate;
a heat radiator including a heat radiating plate having a cavity provided at a center thereof open toward a front surface thereof and receiving the light source module therein and a plurality of ventilation holes disposed along an edge of the cavity, and a plurality of heat radiating fins extending to a rear surface of the heat radiating plate and disposed in a radial manner along an edge of the heat radiating plate to dissipate heat generated by the light source module, and positioned between the plurality of ventilation holes to form ventilation channels therebetween communicating with the plurality of ventilation holes;
a cooler fixed to the heat radiator to be in contact with ends of the heat radiating fins and including a plurality of air jet holes in a surface thereof such that air is blown to the heat radiator; and
an electrical connector connected to the light source module and the cooler and supplying an external electrical signal to the at least one light emitting device package and the cooler.

2. The illuminating device of claim 1, wherein the heat radiating plate includes a plurality of exhaust holes disposed along an inner circumferential surface of the cavity and communicating with the respective ventilation channels.

3. The illuminating device of claim 1, wherein the cooler includes:
a main body having an internal space having a predetermined size and including the plurality of air jet holes in a surface thereof facing the heat radiating fins;
a membrane structure disposed inside the main body and generating an air flow through a vertical rocking motion to allow the air to be blown to the heat radiating fins through the air jet holes; and
an actuator driving the membrane structure to perform the vertical rocking motion when the electrical signal is applied thereto.

4. The illuminating device of claim 1, wherein the plurality of air jet holes are disposed along an edge of the main body and positioned between the plurality of heat radiating fins to allow the air to be blown between the respective heat radiating fins.

5. The illuminating device of claim 1, further comprising a cover member disposed on the front surface of the heat radiating plate to cover the cavity and protect the light source module.

6. The illuminating device of claim 5, wherein the cover member includes an insertion hole provided in a position corresponding to the at least one light emitting device package to allow a portion of the at least one light emitting device package to be exposed to the outside.

7. An illuminating device comprising:
a light source module including a substrate and at least one light emitting device package mounted on the substrate;
a cooler having the light source module mounted on a surface thereof and cooling the light source module when a refrigerant injected thereinto is evaporated and discharged as vapor;
a heat radiator including a heat radiating plate having a cavity provided at a center thereof open toward a front surface thereof and receiving the light source module and the cooler therein and a plurality of ventilation holes disposed along an edge of the cavity, and a plurality of heat radiating fins extending to a rear surface of the heat radiating plate, disposed in a radial manner along an edge of the heat radiating plate, and positioned between the plurality of ventilation holes to form ventilation channels therebetween communicating with the plurality of ventilation holes; and
an electrical connector connected to the light source module and the cooler and supplying an external electrical signal to the at least one light emitting device package and the cooler.

8. The illuminating device of claim 7, wherein the heat radiating plate includes a plurality of exhaust holes disposed along an inner circumferential surface of the cavity to communicate with the respective ventilation channels.

9. The illuminating device of claim 7, wherein the cooler includes:
a main body having a reservoir receiving the refrigerant through a supply pipe and having a predetermined size, and an evaporation space communicating with the reservoir through a plurality of nozzles and allowing the refrigerant injected through the plurality of nozzles to be evaporated and discharged as vapor through a discharge pipe; and
a condenser connected to the supply pipe and the discharge pipe to supply the refrigerant to the reservoir and receive the evaporated vapor from the evaporation space.

10. The illuminating device of claim 9, wherein the supply pipe and the discharge pipe are disposed in a surface of the main body opposite to the surface thereof on which the light source module is mounted.

11. The illuminating device of claim 9, further comprising a pump allowing the refrigerant inside the condenser to be supplied to the reservoir through the supply pipe.

12. The illuminating device of claim 7, further comprising a cover member disposed on the front surface of the heat radiating plate to cover the cavity and protect the light source module.

13. The illuminating device of claim 12, wherein the cover member includes an insertion hole provided in a position corresponding to the at least one light emitting device package to allow a portion of the at least one light emitting device package to be exposed to the outside.
